(19) United States
(12) Patent Application Publication
(10) Pub. No.: US 2013/0200878 A1
(43) Pub. Date: Aug. 8, 2013

(54) ULTRA-LOW NOISE VOLTAGE REFERENCE CIRCUIT

(71) Applicant: ANALOG DEVICES, INC., Norwood, MA (US)

(72) Inventors: Arthur J. Kalb, Santa Clara, CA (US); John Sawa Shafran, San Jose, CA (US)

(73) Assignee: ANALOG DEVICES, INC., Norwood, MA (US)

(21) Appl. No.: 13/757,241

(22) Filed: Feb. 1, 2013

Related U.S. Application Data
(60) Provisional application No. 61/594,851, filed on Feb. 3, 2012.

(51) Int. Cl. G05F 3/16

(52) U.S. Cl. CPC G05F 3/16
USPC 323/313

(57) ABSTRACT

A voltage reference circuit comprises a plurality of ΔV_{BE} cells, each comprising four bipolar junction transistors (BJTs) connected in a cross-quad configuration and arranged to generate a ΔV_{BE} voltage. The plurality of ΔV_{BE} cells are stacked such that their ΔV_{BE} voltages are summed. A last stage is coupled to the summed ΔV_{BE} voltages and arranged to generate one or more V_{BE} voltages which are summed with the ΔV_{BE} voltages to provide a reference voltage. This arrangement serves to cancel out first-order noise and mismatch associated with the two current sources present in each ΔV_{BE} cell, such that the voltage reference circuit provides ultra-low 1/f noise in the bandgap voltage output.

### RELATED APPLICATIONS

This application claims the benefit of provisional patent application No. 61/594,851 to Kalb et al., filed Feb. 3, 2012.

### BACKGROUND OF THE INVENTION

1. Field of the Invention

This invention relates generally to voltage reference circuits, and more particularly to voltage reference circuits having very low noise specifications.

2. Description of the Related Art

One type of voltage reference circuit having a low or zero temperature coefficient (TC) is the bandgap voltage reference. The low TC is achieved by generating a voltage having a positive TC (PTAT) and summing it with a voltage having a negative TC (CTAT) to create a reference voltage with a first-order zero TC. One conventional method of generating a bandgap reference voltage is shown in FIG. 1. An amplifier 10 provides equal currents to bipolar junction transistors (BJTs) Q1 and Q2; however, the emitter areas of Q1 and Q2 are intentionally made different, such that the base-emitter voltages for the two transistors are different. This difference, ΔV_{BE}, is a PTAT voltage which appears across resistor R2. It is summed with the base-emitter voltage (V_{BE}) of Q1, which is a CTAT voltage, to generate reference voltage V_{REF}, which is given by:

V_{REF}=V_{BE,Q1}+V_{PTAT}=T_{BE,Q1}+K(V_{T} ln(+V_{OS}),

where K=R₁/R₂, V_{T} is the thermal voltage, N is the ratio of the emitter areas and V_{OS} is the offset voltage of amplifier 10.

When so arranged, the noise v_{n,PTAT} generated in the creation of the PTAT voltage is given by:

v_{n,PTAT}=\sqrt{(v_{n,amp}²+v_{n,Q1}²+v_{n,Q2}²+v_{n,R2}²)K²+v_{n,R1}²}

Another bandgap voltage reference approach, described in U.S. Pat. No. 8,228,052 to Marinca, is illustrated in FIG. 2. Explicit amplifiers are not used with this ΔV_{BE} voltage generation method in favor of stacked, independent ΔV_{BE} cells. Here, the output of the voltage reference is given by:

V_{REF}=ΔV_{BE1}+ΔV_{BE2}+ . . . +ΔV_{BEK}+V_{BE}

The noise of each ΔV_{BE} cell is uncorrelated with the others; thus, the noise contributions to the PTAT voltage, v_{n,PTAT}, sum in an RMS fashion as given by:

v_{n,PTAT}=\sqrt{v_{n,ΔVBE1}²+v_{n,ΔVBE2}+ . . . +v_{n,ΔVBEK}²}

Though this approach generates less noise that the conventional approach shown in FIG. 1, the noise level may still be unacceptably high for certain implementations.

### SUMMARY OF THE INVENTION

A voltage reference circuit is presented which is capable of providing a noise figure lower than those associated with the prior art methods described above.

The present voltage reference circuit comprises a plurality of ΔV_{BE} cells, each comprising four bipolar junction transistors (BJTs) connected in a cross-quad configuration and arranged to generate a ΔV_{BE} voltage. The plurality of ΔV_{BE} cells are stacked such that their ΔV_{BE} voltages are summed. A last stage is coupled to the summed ΔV_{BE} voltages; the last stage is arranged to generate a V_{BE} voltage which is summed with the ΔV_{BE} voltages to provide a reference voltage. This arrangement serves to cancel out the first-order noise and mismatch associated with the two current sources present in each ΔV_{BE} cell, such that the present voltage reference circuit provides ultra-low 1/f noise in the bandgap voltage output.

These and other features, aspects, and advantages of the present invention will become better understood with reference to the following description and claims.

### BRIEF DESCRIPTION OF THE DRAWINGS

FIG. 1 is a schematic diagram of a known bandgap voltage reference.

FIG. 2 is a block diagram of another known bandgap voltage reference.

FIG. 3 is a schematic diagram of a ΔV_{BE} cell.

FIG. 4 is a plot of the constituent noise components of a ΔV_{BE} cell such as that shown in FIG. 3.

FIG. 5 is a schematic diagram of a quad ΔV_{BE} cell.

FIG. 6 is a plot of the constituent noise components of a quad ΔV_{BE} cell such as that shown in FIG. 5.

FIG. 7 is a schematic diagram of a cross-quad ΔV_{BE} cell.

FIG. 8 is a plot comparing the noise of a cross-quad ΔV_{BE} with that of quad ΔV_{BE} cell and a basic ΔV_{BE} cell.

FIG. 9 is a plot of the constituent noise components of a cross-quad ΔV_{BE} cell such as that shown in FIG. 7.

FIG. 10 is a schematic diagram of one possible embodiment of an ultra-low noise voltage reference circuit in accordance with the present invention.

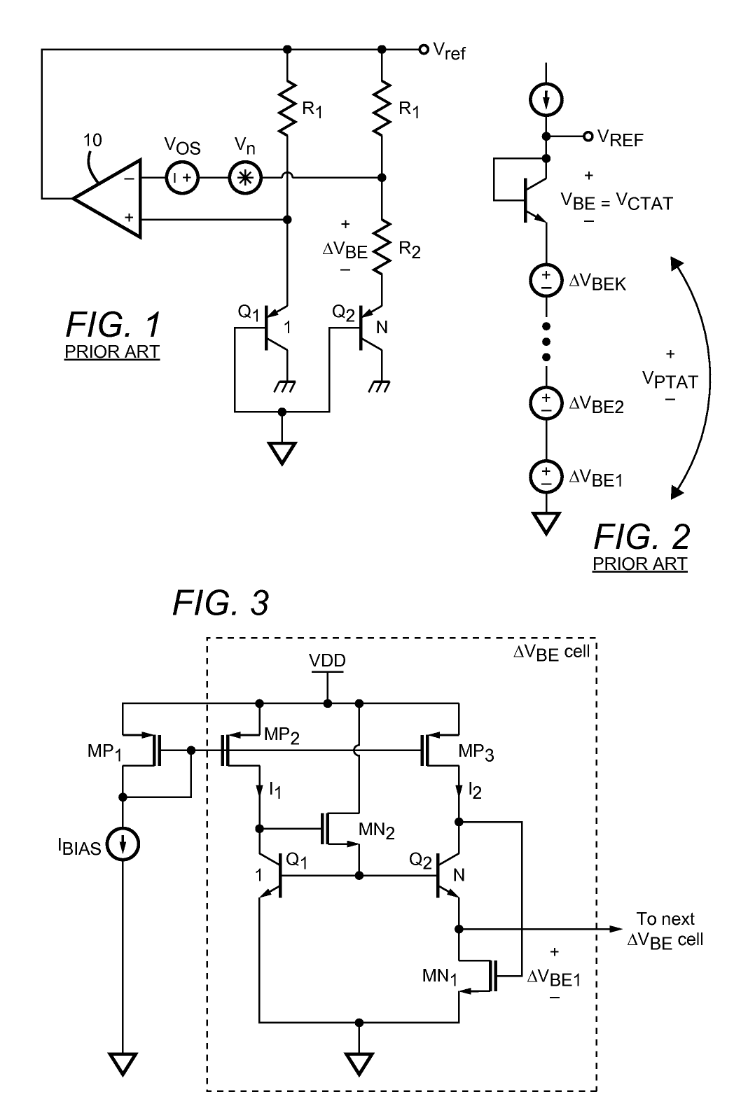

### DETAILED DESCRIPTION OF THE INVENTION

One possible implementation of a cell capable of generating a ΔV_{BE} voltage is shown in FIG. 3 (Marinca, ibid.). BJTs Q₁ and Q₂ are arranged such that the emitter area of Q₂ is N times that of Q₁, and FETs MP₁ and MP₂ are arranged to provide equal currents I₁ and I₂ to Q₁ and Q₂, respectively. An NMOS FET MN₁ functions as a resistance across which the cell's output voltage (ΔVBE) appears, given by:

$$\begin{matrix}Δ {V}_{BE} = {V}_{BE , Q 1} - {V}_{BE , Q 2} \\ = {V}_{T} ln ( \frac{{I}_{C 1}}{{I}_{S 1}} ) - {V}_{T} ln ( \frac{{I}_{C 2}}{{I}_{S 2}} ) \\ = {V}_{T} ln ( \frac{{I}_{C 1}}{{I}_{S 1}} \cdot \frac{{I}_{S 2}}{{I}_{C 2}} ) \\ ≡ {V}_{T} ln ( N )\end{matrix}$$

wherein V_{T} is the thermal voltage, I_{C1} and I_{C2} are the collector currents of Q1 and Q2, respectively, and I_{S1} and I_{S2} are the saturation currents of Q1 and Q2, respectively. Thus, the ΔV_{BE} voltage is purely dependent on the emitter area ratio, nominally N, of NPNs Q₁ and Q₂, the matching of currents I₁ and I₂ (generated by the PMOS current mirror transistors MP₂ and MP₃), and the matching of Q₁ and Q₂. NMOS FET MN₁ acts as a variable resistor, which is tuned by the circuit to sink the current necessary to keep the cell in an equilibrium state. Multiple ΔV_{BE} cells of this sort could be “stacked”—i.e., connected such that their individual ΔV_{BE} voltages are summed—and then coupled to a stage which adds a V_{BE} voltage to the summed ΔV_{BE} voltages to provide a voltage reference circuit. An NMOS FET MN₂ is preferably connected as shown and used to drive the bases of Q1 and Q2, though other means might also be used; a BJT might also be used for this purpose.

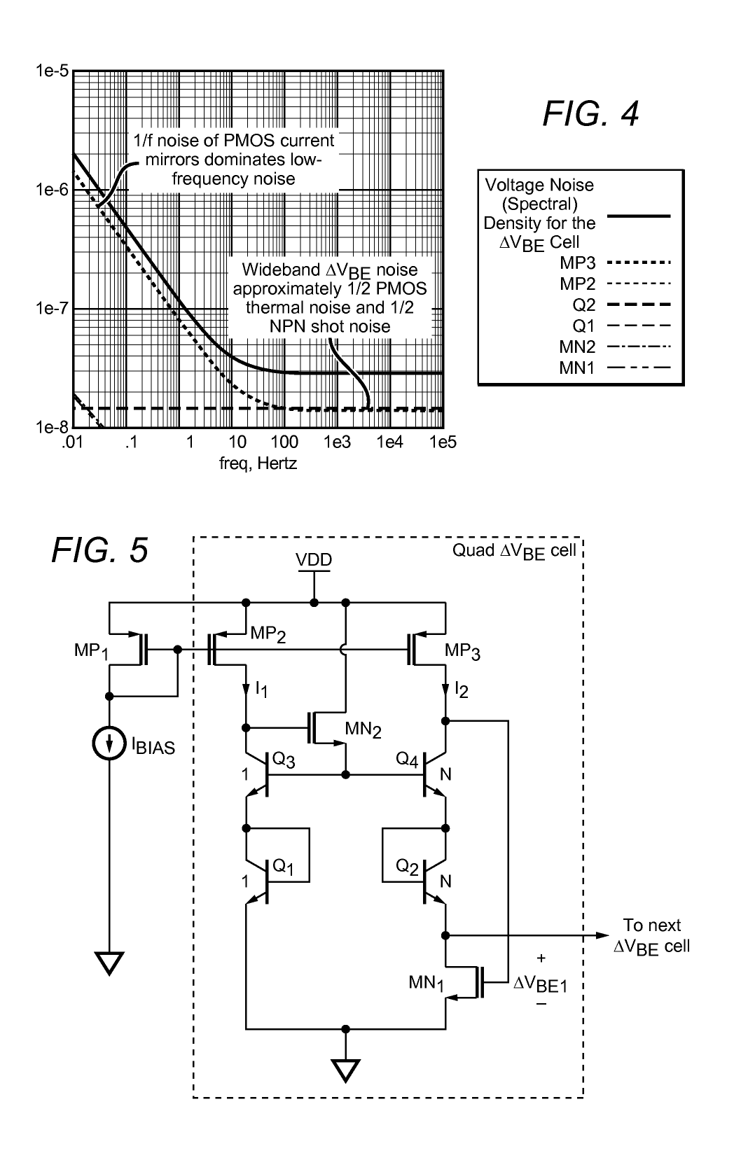

The constituent noise components of a ΔV_{BE} cell such as that shown in FIG. 3, designed on a standard CMOS process, are shown in FIG. 4. At frequencies below 10 Hz, the 1/f noise of the PMOS FETs MP₂ and MP₃ dominates. Above 10 Hz, the overall ΔV_{BE} noise is split approximately equally between the PMOS current mirror thermal noise and the shot noise of NPNs Q₁ and Q₂. Note that even if MP₂ and MP₃ match perfectly, the small-signal collector currents of Q₁ and Q₂ are not equal because MP₂ and MP₃ each has its own uncorrelated noise; this differential noise results in noise in the ΔV_{BE} output. The 1/f noise is more pronounced in MOS devices than bipolar devices; thus, the contribution of the PMOS noise to the total noise is dominant at frequencies below 10 Hz in FIG. 4.

One could theoretically improve the noise performance of the ΔV_{BE} cell discussed above by using two sets of two NPNs to create the ΔV_{BE} voltage. This approach, referred to herein as a “quad ΔV_{BE} cell” for its four NPNs, is shown in FIG. 5. Note that, as above, multiple quad ΔV_{BE} cells could be stacked and coupled to a stage which adds a V_{BE} voltage to the summed ΔV_{BE} voltages to provide a voltage reference circuit.

The output voltage ΔV_{BE} of this configuration is given by:

$$\begin{matrix}Δ {V}_{BE} = {V}_{BE , Q 1} + {V}_{BE , Q 3} - {V}_{BE , Q 2} - {V}_{BE , Q 4} \\ = {V}_{T} ln ( \frac{{I}_{C 1}}{{I}_{S 1}} \cdot \frac{{I}_{C 3}}{{I}_{S 3}} \cdot \frac{{I}_{S 2}}{{I}_{C 2}} \cdot \frac{{I}_{S 4}}{{I}_{C 4}} ) \\ ≡ {V}_{T} ln ( {N}^{2} ) \\ = 2 {V}_{T} ln ( N ) , assuming equal β ' s\end{matrix}$$

In the quad ΔV_{BE} cell, the ΔV_{BE} voltage increases by a factor of 2, while the NPN shot noise contribution to the ΔV_{BE} voltage increases by a factor of √2 since the NPN shot noise generators are uncorrelated. As a result, the quad ΔV_{BE} cell provides a signal-to-noise ratio (SNR) improvement of:

√((4/6)/(1/2))=√(4/3)=˜1.15,

if the overall wideband ΔV_{BE} noise is split evenly between PMOS thermal noise and NPN shot noise.

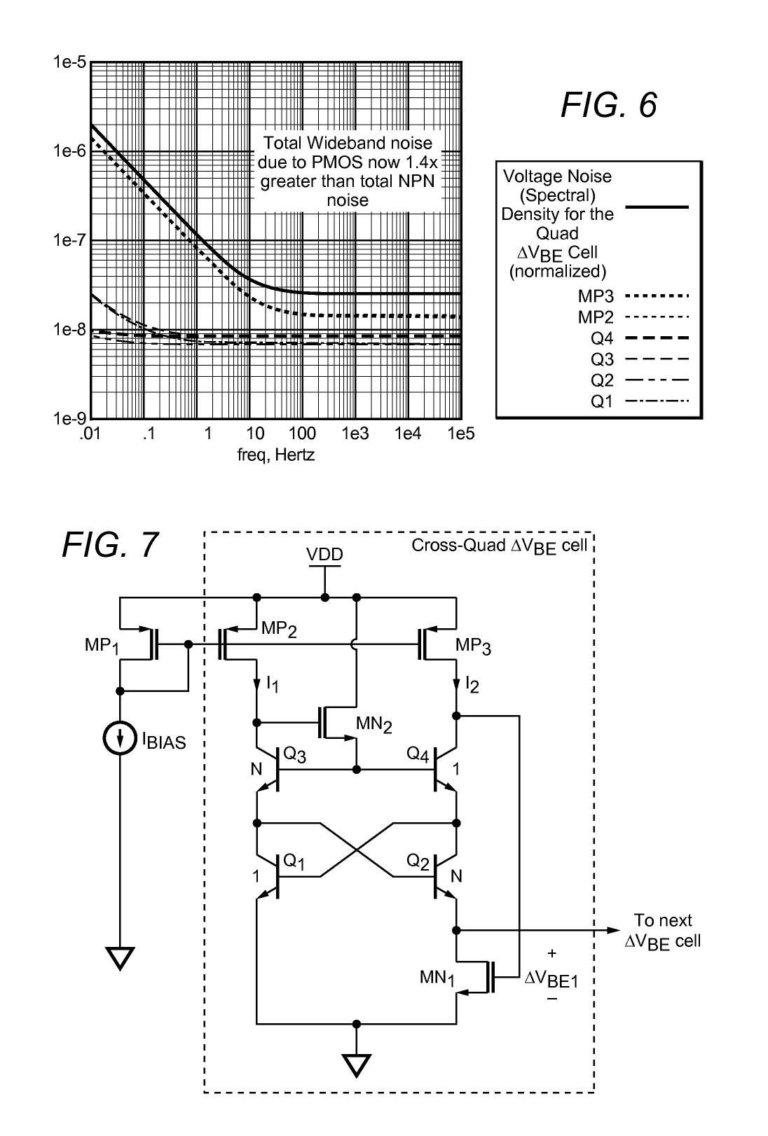

As noted above, the quad cell increases ΔV_{BE} magnitude by a factor of 2, which corresponds with an increase in signal power by 4. However, the PMOS noise magnitude also doubles (it sees twice the gain in converting from current to voltage), so it increases in power by 4. The shot noise increases because of a doubling in the number of noise generators. There are twice as many noise generators, so the shot noise power goes up by 2. FIG. 6 depicts the constituent noise components of the quad ΔV_{BE} cell.

A closer look at the quad ΔV_{BE} cell reveals that I₁≠I₂ in a small-signal sense due to the uncorrelated noise of the PMOS current mirrors MP₂ and MP₃. The high-current-density pair Q₁ and Q₃ sees I₁ with its independent noise, while the low-current-density pair Q₂ and Q₄ sees I₂ with its own independent noise. The uncorrelated nature of the PMOS noise sources leads to noise in the generation of the ΔV_{BE} voltage with the quad ΔV_{BE} cell. Thus, while the SNR of the quad ΔV_{BE} cell is improved over the standard ΔVBE cell, the performance may still be unacceptable for some applications.

A voltage reference circuit capable of providing ultra-low noise performance is now described. The present voltage reference circuit employs a “cross-quad ΔV_{BE} cell” that to first-order cancels out the noise and mismatch of the two current sources which provide currents I₁ and I₂. Without the cross-quad connection, the current sources can be the dominant sources of noise and mismatch in the overall ΔV_{BE} output voltage. Here, however, the voltage reference provides ultra-low 1/f noise in the bandgap voltage output, making it suitable for demanding applications such as medical instrumentation. For example, one possible application is as an ultra-low-noise voltage reference for an electrocardiograph (ECG) medical application-specific standard product (ASSP).

A schematic of a preferred embodiment of the cross-quad ΔV_{BE} cell is shown in FIG. 7. The output of this arrangement is given by:

$$Δ {V}_{BE} = {V}_{BE , Q 1} + {V}_{BE , Q 4} - {V}_{BE , Q 3} - {V}_{BE , Q 2} = {V}_{T} ln ( \frac{{I}_{C 1} \cdot {I}_{C 4}}{{I}_{C 2} \cdot {I}_{C 3}} \frac{{I}_{S 2} \cdot {I}_{S 3}}{{I}_{S 1} \cdot {I}_{S 4}} )$$

where I_{S1} , I_{C1}, I_{S2}, I_{C2}, I_{S3}, I_{C3}, I_{S4}, and I_{C4} are the saturation and collector currents of transistors Q1, Q2, Q3, and Q4, respectively.

Since I_{C3}=I₁ and I_{C4}=I₂, it can be shown that:

$${I}_{C 1} = + \frac{{β}_{1} {β}_{2} {β}_{3}}{( {β}_{3} + 1 ) ( {β}_{1} {β}_{2} - 1 )} {I}_{1} - \frac{{β}_{1} {β}_{4}}{( {β}_{4} + 1 ) ( {β}_{1} {β}_{2} - 1 )} {I}_{2}$$

$$and$$

$${I}_{C 2} = - \frac{{β}_{2} {β}_{3}}{( {β}_{3} + 1 ) ( {β}_{1} {β}_{2} - 1 )} {I}_{1} + \frac{{β}_{1} {β}_{2} {β}_{4}}{( {β}_{4} + 1 ) ( {β}_{1} {β}_{2} - 1 )} {I}_{2}$$

where, β₁, β₂, β₃ and β₄ are the current gains of transistors Q1, Q2, Q3, and Q4, respectively. Typically, transistors Q1 and Q4 will have an emitter area, A, and transistors Q2 and Q4 will have an emitter area N*A. Then, the output is given by:

$$Δ {V}_{BE} = {V}_{BE , Q 1} + {V}_{BE , Q 4} - {V}_{BE , Q 3} - {V}_{BE , Q 2} = {V}_{T} ln ( {N}^{2} \cdot \frac{{I}_{C 1} \cdot {I}_{C 4}}{{I}_{C 2} \cdot {I}_{C 3}} )$$

It should be noted that other scalings of the emitter areas are possible. As above, NMOS FET MN₁ is preferably employed as a resistance across which the cell's output voltage (ΔV_{BE}) appears, and NMOS FET MN₂ is preferably connected as shown to drive the bases of Q1 and Q2; note, however, that MN₂ might alternatively be implemented with an NPN transistor, and that the functions provided by MN₁ and MN₂ might alternatively be provided by other means.

In this configuration, the high-current-density pair Q₁ and Q₃ and the low-current-density pair Q₂ and Q₄ each have one NPN with a collector current originating from I₁ and one NPN with a collector current originating from I₂. The noise components introduced by MP₂ and MP₃ are forced to be correlated via the cross-quad configuration. Thus, the 1/f and wideband noise, and the mismatch of the PMOS current mirror transistors, are rejected to an amount limited only by the β of the NPNs used in the cross-quad configuration.

The last statement can be better appreciated by revisiting the I_{C1} and I_{C3} equations shown above, which indicate that currents I_{C1} and I_{C3} are not perfectly correlated due to finite β. Current I_{C3} is purely a function of I₁, while I_{C1} is a function of I₁ and I₂; the relative contribution of I₂ to I_{C1} depends on β. The same condition applies to I_{C2} and I_{C4}. The sensitivity of the ΔV_{BE} voltage to noise in the current sources can be calculated as the partial derivative of the ΔV_{BE} voltage with respect to each current. For simplicity of calculation, the transistor current gains will be assumed to be equal to β and the calculation will be carried out at the nominal operating point I1=I2=I. The sensitivities are then given by:

$$\frac{\partial }{\partial {I}_{1}} Δ {V}_{BE} = \frac{\partial }{\partial {I}_{1}} {V}_{T} ln ( {N}^{2} \cdot \frac{{I}_{C 1} \cdot {I}_{C 4}}{{I}_{C 2} \cdot {I}_{C 3}} ) = \frac{2}{β - 1} \cdot \frac{{V}_{T}}{I}$$

$$\frac{\partial }{\partial {I}_{2}} Δ {V}_{BE} = \frac{\partial }{\partial {I}_{2}} {V}_{T} ln ( {N}^{2} \cdot \frac{{I}_{C 1} \cdot {I}_{C 4}}{{I}_{C 2} \cdot {I}_{C 3}} ) = - \frac{2}{β - 1} \cdot \frac{{V}_{T}}{I}$$

It is clear that the sensitivities are inversely proportional to the current gain, β. The conclusion is that the PMOS current source noise suppression is limited by β, with greater suppression achieved when using fabrication processes that enable larger β.

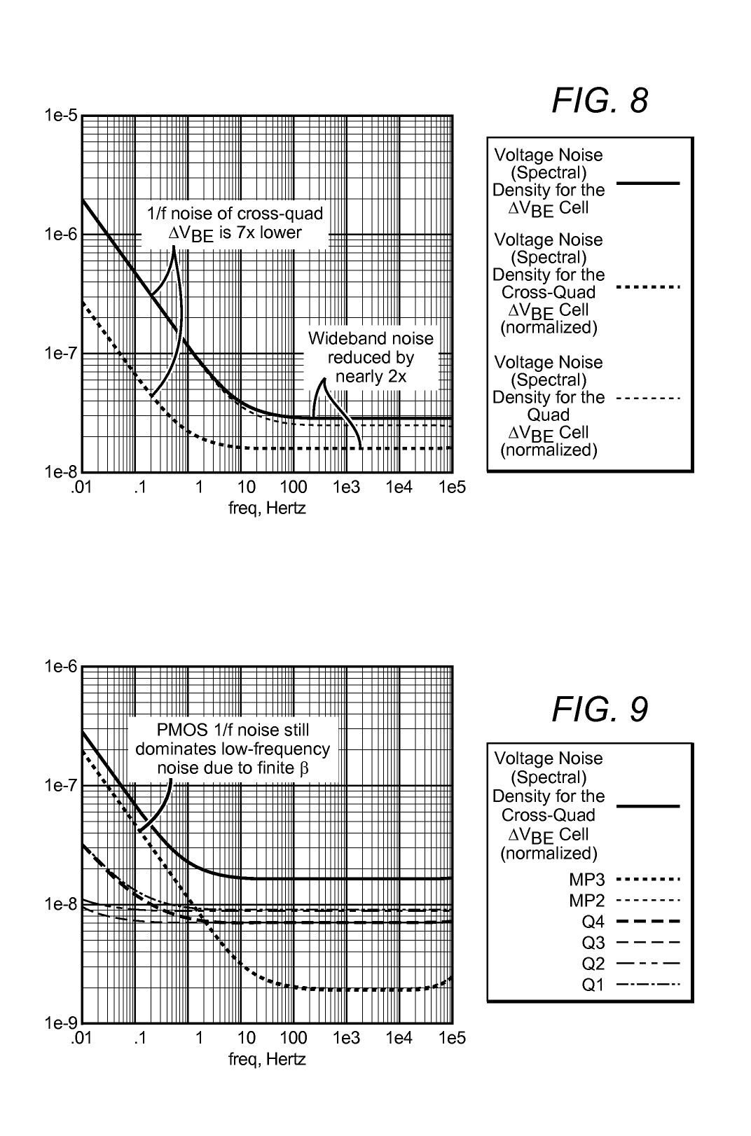

A comparison of the noise of the cross-quad ΔV_{BE} cell with the quad and standard ΔV_{BE} cells is shown in FIG. 8. The 1/f noise of the cross-quad ΔV_{BE} cell is 7× lower than that of the quad and standard ΔV_{BE} cells (the β for the process was approximately 8), and the wideband noise is reduced by nearly 2× over the standard cell. FIG. 9 shows the constituent noise components of the cross-quad ΔV_{BE} cell. Due to finite β as described earlier, there is still a 1/f noise component due to the PMOS current minors; however, the overall contribution of the PMOS current mirror noise is reduced because of the cross-quad ΔV_{BE} configuration.

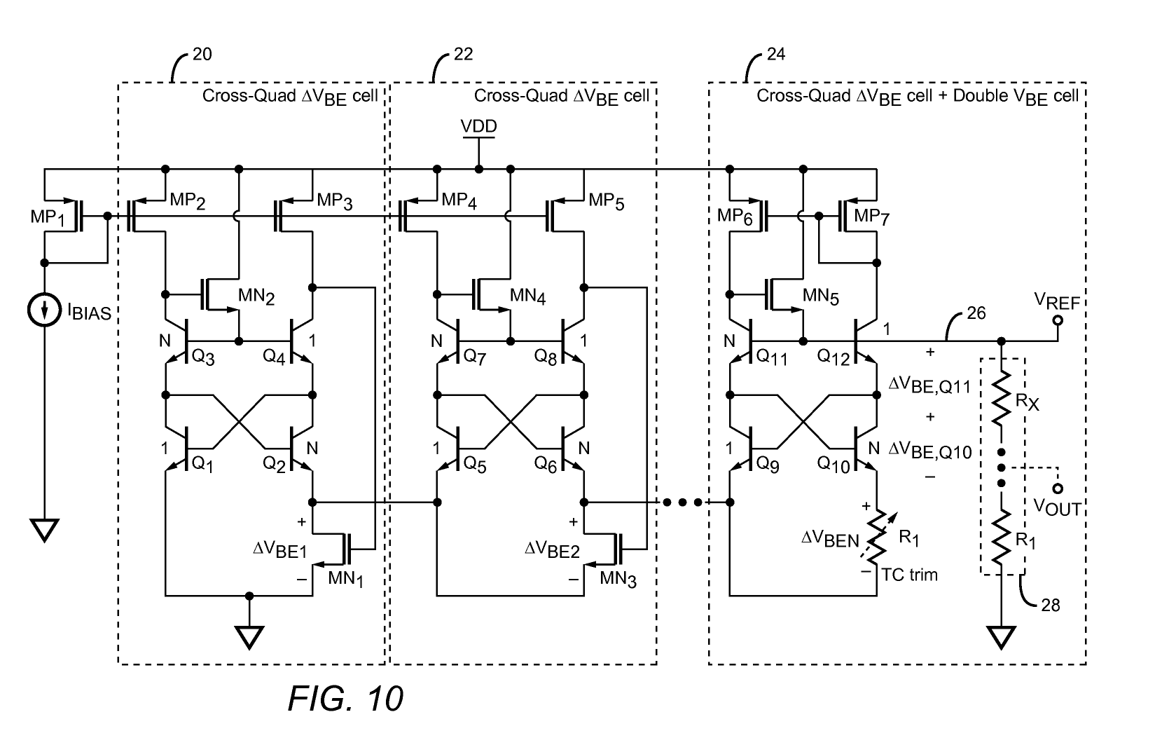

Multiple cross-quad ΔV_{BE} cells can be stacked together and then coupled to a last stage to create a first-order zero TC voltage reference with ultra-low noise; one possible embodiment is shown in FIG. 10. Two cross-quad ΔV_{BE} cells 20 and 22 are shown in FIG. 10, though more or fewer cross-quad ΔV_{BE} cells could be used as needed. The stacked cross-quad ΔV_{BE} cells are connected such that their individual ΔV_{BE} voltages are summed. In the exemplary embodiment shown, this is accomplished by connecting the ΔV_{BE} voltage that appears across the resistance (MN1) in first cross-quad ΔV_{BE} cell 20 to the circuit common point of the second cross-quad ΔV_{BE} cell in the stack, connecting the ΔV_{BE} voltage across the resistance (MN3) in second cross-quad ΔV_{BE} cell 22 to the circuit common point of the third cross-quad ΔV_{BE} cell in the stack (if present), and so on.

The ΔV_{BE} voltage that appears across the resistance in the last cross-quad ΔV_{BE} cell in the stack is connected to a last stage 24, which, in the exemplary embodiment shown, is nearly identical to the other cross-quad ΔV_{BE} cells. The output 26 (V_{REF}) of the last stage is taken from the base of Q₁₁ and Q₁₂ such that the last stage contributes a cross-quad ΔV_{BE} voltage to the reference voltage output, along with two full V_{BE} voltages which provide the CTAT component of the voltage reference. The ΔV_{BE} voltage provided by the last stage is given by:

$$\begin{matrix}Δ {V}_{BE} = {V}_{BE , Q 9} + {V}_{BE , Q 12} - {V}_{BE , Q 11} - {V}_{BE , Q 10} \\ = {V}_{T} ln ( {N}^{2} \frac{{I}_{C 9} \cdot {I}_{C 12}}{{I}_{C 11} \cdot {I}_{C 10}} \frac{{I}_{S 11} \cdot {I}_{S 10}}{{I}_{S 9} \cdot {I}_{S 12}} ) ,\end{matrix}$$

where V_{T} is the thermal voltage and I_{C9}, I_{C10}, I_{C11} and I_{C12} are the collector currents of Q9, Q10, Q11 and Q12, respectively. The voltage reference V_{REF} is then given by:

V_{REF}=ΔV_{BE1}+ΔV_{BE2}+ . . . +ΔV_{BEK}+(2*V_{BE}).

Note that the currents in the last stage are sourced by a minor configuration (with MP7 diode-connected), instead of via two current sources as in the cross-quad ΔV_{BE} cells. Also, rather than using an NMOS FET as a resistance across which the cell's ΔV_{BE} voltage appears as in the preferred embodiment of the cross-quad cell, here the stage current is set by a resistor R₁, which may be made variable to provide a trim mechanism for the TC.

Most of the error in such circuits is due to the V_{BE} term. In theory, V_{BE} intersects VG0 (the bandgap voltage) at 0K. The slope away from 0K is determined by the sizing of the transistor providing the V_{BE} voltage and the current through it—which will vary for each transistor and each die. Prior art designs typically add a fraction of a V_{BE} voltage to a ΔV_{BE} voltage to obtain a zero TC. This means that the circuit adds K*VG0 at 0K, and 0 at some unknown temperature; that trim scheme rotates the V_{BE} curve around the unknown temperature. The net result is that the “magic voltage” at which the bandgap voltage reference has zero TC changes from die to die. This makes trimming difficult, with both TC trim and gain trim mechanisms needed to provide acceptable performance.

The present trim scheme is to change the final stage current to affect a change in V_{BE}. This rotates the V_{BE} curve around VG0 at 0K, and allows for the size and current errors to be nulled out in the same mathematical way as they enter. The end result is that the reference voltage output has zero TC at the same magic voltage for each die (assuming VG0 is not changing). This allows for a simple single point trim of the TC. Ideally, only a TC trim mechanism is needed, as the output will always be at the magic voltage. The output voltage of the reference is then divided down (via, for example, a voltage divider 26) to get a desired output voltage V_{OUT}.

The cross-quad ΔV_{BE} cell is described and shown as consisting of two NPNs as the ΔV_{BE} generators, two PMOS devices as the current minors, and an NMOS device as the variable resistor. However, it is conceivable that one could use, for example, NMOS FETs in weak inversion in lieu of the NPNs, or PNPs instead of PMOS FETs for the current minors, or an NPN instead of an NMOS FET MN2. Any variant of the ΔV_{BE} cell could be improved by the cross-quad technique.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

We claim:

1. A voltage reference circuit, comprising:
a plurality of ΔV_{BE} cells, each comprising four bipolar junction transistors (BJTs) connected in a cross-quad configuration and arranged to generate a ΔV_{BE} voltage, said plurality of ΔV_{BE} cells stacked such that their ΔV_{BE} voltages are summed; and
a last stage which is coupled to said summed ΔV_{BE} voltages, said last stage arranged to generate multiple V_{BE} voltages which are summed with said summed ΔV_{BE} voltages to provide a reference voltage.

2. The voltage reference of claim 1, wherein said voltage reference circuit is arranged such that said reference voltage has a first-order temperature coefficient of zero.

3. The voltage reference of claim 1, wherein each of said ΔV_{BE} cells comprises:
a first bipolar junction transistor (BJT) Q1 having an area A₁ with its base terminal connected to a first node, emitter terminal connected to a circuit common point, and collector terminal connected to a second node;
a second bipolar junction transistor (BJT) Q2 having an area A₂ with its base terminal connected to said second node, emitter terminal connected to a third node, and collector terminal connected to said first node;
a third bipolar junction transistor (BJT) Q3 having an area A₃ with its base terminal connected to a fourth node, emitter terminal connected to said second node, and collector terminal connected to a fifth node;
a fourth bipolar junction transistor (BJT) Q4 having an area A₄ with its base terminal connected to said fourth node, emitter terminal connected to said first node, and collector terminal connected to a sixth node;
said fifth and sixth nodes receiving first and second currents I1 and I2, respectively; and
a resistance connected between said third node and said circuit common point;
such that a ΔV_{BE} voltage is produced across said resistance given by:
$$\begin{matrix}Δ {V}_{BE} = {V}_{BE , Q 1} + {V}_{BE , Q 4} - {V}_{BE , Q 3} - {V}_{BE , Q 2} \\ = {V}_{T} ln ( \frac{{I}_{S 2} \cdot {I}_{S 3}}{{I}_{S 1} \cdot {I}_{S 4}} \cdot \frac{{I}_{C 1} \cdot {I}_{C 4}}{{I}_{C 2} \cdot {I}_{C 3}} ) ,\end{matrix}$$
where I_{S1}, I_{C1}, I_{S2}, I_{C2}, I_{S3}, I_{C3}, I_{S4}, and I_{C4} are the saturation and collector currents of Q1, Q2, Q3 and Q4, respectively, and I_{C3}=I1 and I_{C4}=I2.

4. The voltage reference of claim 3, wherein said first and second currents are provided by current sources.

5. The voltage reference of claim 4, wherein said first and second currents are provided by:
a fixed current source;
a diode-connected transistor; and
first and second minor transistors, said diode-connected transistor and said first and second minor transistors connected such that the current provided by said fixed current source is mirrored to said third and fourth nodes, said mirrored currents being I1 and I2.

6. The voltage reference of claim 5, wherein said first and second mirror transistors are PMOS FETs or PNP transistors.

7. The voltage reference of claim 3, arranged such that I1=I2.

8. The voltage reference of claim 3, wherein A1=A4 and A2=A3=N*A1, where N≠1.

9. The voltage reference of claim 3, wherein the ΔV_{BE} voltage across the resistance in the first ΔV_{BE} cell in said stack is connected to the circuit common point of the second ΔV_{BE} cell in said stack, the ΔV_{BE} voltage across the resistance in second ΔV_{BE} cell in said stack is connected to the circuit common point of the third ΔV_{BE} cell in said stack, and so on.

10. The voltage reference circuit of claim 3, wherein said resistance is a FET, said FET connected such that it is driven to conduct a current sufficient to maintain said ΔV_{BE} cell in an equilibrium state.

11. The voltage reference circuit of claim 3, further comprising a transistor connected between said fifth node and said fourth node and arranged to drive the bases of Q3 and Q4.

12. The voltage reference circuit of claim 11, wherein said transistor connected between said fifth node and said fourth node is an NMOS FET or an NPN.

13. The voltage reference of claim 1, wherein said last stage comprises:
a ΔV_{BE} cell comprising four bipolar junction transistors (BJTs) connected in a cross-quad configuration and arranged to generate a ΔV_{BE} voltage and at least one V_{BE} voltage which are summed with said summed ΔV_{BE} voltages.

14. The voltage reference of claim 13, wherein said last stage comprises:
a first bipolar junction transistor (BJT) Q1 having an area A₁ with its base terminal connected to a first node, emitter terminal connected to a circuit common point, and collector terminal connected to a second node;
a second bipolar junction transistor (BJT) Q2 having an area A₂ with its base terminal connected to said second node, emitter terminal connected to a third node, and collector terminal connected to said first node;
a third bipolar junction transistor (BJT) Q3 having an area A₃ with its base terminal connected to a fourth node, emitter terminal connected to said second node, and collector terminal connected to a fifth node;
a fourth bipolar junction transistor (BJT) Q4 having an area A₄ with its base terminal connected to said fourth node, emitter terminal connected to said first node, and collector terminal connected to a sixth node;
said fifth and sixth nodes receiving first and second currents I1 and I2, respectively; and
a resistance connected between said third node and said circuit common point;
such that a ΔV_{BE} voltage is produced across said resistance given by:
$$\begin{matrix}Δ {V}_{BE} = {V}_{BE , Q 1} + {V}_{BE , Q 4} - {V}_{BE , Q 3} - {V}_{BE , Q 2} \\ = {V}_{T} ln ( \frac{{I}_{S 2} \cdot {I}_{S 3}}{{I}_{S 1} \cdot {I}_{S 4}} \cdot \frac{{I}_{C 1} \cdot {I}_{C 4}}{{I}_{C 2} \cdot {I}_{C 3}} ) ,\end{matrix}$$
where I_{S1}, I_{C1}, I_{S2}, I_{C2}, I_{S3}, I_{C3}, I_{S4}, and I_{C4} are the saturation and collector currents of Q1, Q2, Q3 and Q4, respectively, and I_{C3}=I1 and I_{C4}=I2;
said last stage's circuit common point connected to receive said summed ΔV_{BE} voltages;
said reference voltage taken at a node such that said summed ΔV_{BE} voltages are summed with at least one V_{BE} voltage.

15. The voltage reference of claim 14, wherein said reference voltage is taken at said fourth node such that said summed ΔV_{BE} voltages are summed with the V_{BE} voltages of said second and third BJTs.

16. The voltage reference of claim 14, wherein said reference voltage is taken at said first node such that said summed ΔV_{BE} voltages are summed with the V_{BE} voltage of said first BJT.

17. The voltage reference of claim 14, wherein said reference voltage is taken at said second node such that said summed ΔV_{BE} voltages are summed with the V_{BE} voltage of said second BJT.

18. The voltage reference of claim 14, wherein said last stage has an associated supply voltage, further comprising a supply-voltage referred current mirror arranged to mirror said current I2 to said fifth node to provide said current I1.

19. The voltage reference of claim 14, wherein said resistance is a variable resistance, such that the temperature coefficient of said reference voltage can be trimmed by varying said resistance.

20. A ΔV_{BE} generating circuit formed from a plurality of ΔV_{BE} cells, each comprising:
a first bipolar junction transistor (BJT) Q1 having an area A₁ with its base terminal connected to a first node, emitter terminal connected to a circuit common point, and collector terminal connected to a second node;
a second bipolar junction transistor (BJT) Q2 having an area A₂ with its base terminal connected to said second node, emitter terminal connected to a third node, and collector terminal connected to said first node;
a third bipolar junction transistor (BJT) Q3 having an area A₃ with its base terminal connected to a fourth node, emitter terminal connected to said second node, and collector terminal connected to a fifth node;
a fourth bipolar junction transistor (BJT) Q4 having an area A₄ with its base terminal connected to said fourth node, emitter terminal connected to said first node, and collector terminal connected to a sixth node;
said fifth and sixth nodes receiving first and second currents I1 and I2, respectively; and
a resistance connected between said third node and said circuit common point;
such that a ΔV_{BE} voltage is produced across said resistance given by:
$$\begin{matrix}Δ {V}_{BE} = {V}_{BE , Q 1} + {V}_{BE , Q 4} - {V}_{BE , Q 3} - {V}_{BE , Q 2} \\ = {V}_{T} ln ( \frac{{I}_{S 2} \cdot {I}_{S 3}}{{I}_{S 1} \cdot {I}_{S 4}} \cdot \frac{{I}_{C 1} \cdot {I}_{C 4}}{{I}_{C 2} \cdot {I}_{C 3}} ) ,\end{matrix}$$
where I_{S1}, I_{C1}, I_{S2}, I_{C2}, I_{S3}, I_{C3}, I_{S4}, and I_{C4} are the saturation and collector currents of Q1, Q2, Q3 and Q4, respectively, and I_{C3}=I1 and I_{C4}=I2.

21. The ΔV_{BE} generating circuit of claim 20, wherein the ΔV_{BE} voltage across the resistance in the first ΔV_{BE} cell in said stack is connected to the circuit common point of the second ΔV_{BE} cell in said stack, the ΔV_{BE} voltage across the resistance in second ΔV_{BE} cell in said stack is connected to the circuit common point of the third ΔV_{BE} cell in said stack, and so on.

22. The ΔV_{BE} generating circuit of claim 20, wherein said resistance is a FET, said FET connected such that it is driven to conduct a current sufficient to maintain said ΔV_{BE} cell in an equilibrium state.

23. The ΔV_{BE} generating circuit of claim 20, further comprising a transistor connected between said fifth node and said fourth node and arranged to drive the bases of Q3 and Q4.

24. A ΔV_{BE} generating circuit formed from a plurality of ΔV_{BE} cells, each comprising:
a first NMOS FET Q1 having an area A₁ with its gate terminal connected to a first node, source terminal connected to a circuit common point, and drain terminal connected to a second node;
a second NMOS FET Q2 having an area A₂ with its gate terminal connected to said second node, source terminal connected to a third node, and drain terminal connected to said first node;
a third NMOS FET Q3 having an area A₃ with its gate terminal connected to a fourth node, source terminal connected to said second node, and drain terminal connected to a fifth node;
a fourth NMOS FET Q4 having an area A₄ with its gate terminal connected to said fourth node, source terminal connected to said first node, and drain terminal connected to a sixth node, said NMOS FETs each operated in weak inversion;
said fifth and sixth nodes receiving first and second currents I1 and I2, respectively; and
a resistance connected between said third node and said circuit common point;
such that a ΔV_{BE} voltage is produced across said resistance which is proportional to absolute temperature.

25. The ΔV_{BE} generating circuit of claim 24, further comprising a transistor connected between said fifth node and said fourth node and arranged to drive the bases of Q3 and Q4.
